(19) United States
(12) Patent Application Publication
(10) Pub. No.: US 2006/0167886 A1
(43) Pub. Date: Jul. 27, 2006

(54) System and method for transmitting data from a storage medium to a user-defined cluster of local and remote server blades

(75) Inventors: Rajiv N. Kantesaria, Cary, NC (US); Eric R. Kern, Chapel Hill, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 10/994,864

(22) Filed: Nov. 22, 2004

(51) Int. Cl. G06F 17/30; G06F 7/00

(52) U.S. Cl. 707/10

(57) ABSTRACT

A method is provided to allow for establishing one or more user-defined clusters including server blades in a local blade cabinet and in one or more remote blade cabinets connected to the local cabinet by a management network, and then to allow for the transmission of information read within a local drive unit only to the blade servers within one of the user-defined clusters.

### BACKGROUND OF THE INVENTION

1. Field of the Invention

This invention relates to the transmission of data, including computer instructions, to multiple interconnected computing systems and, more particularly, to transmitting such data and instructions to a user-defined cluster of server blades in a local blade cabinet and in remote blade cabinets.

2. Summary of the Background Art

The patent literature describes a number of methods for transmitting data to multiple interconnected computer systems, such as server blades. For example, U.S. Pat. App. Pub No. 2003/0074431 A1 describes a method for automatically switching remote devices shared by a number of server blades in a dense server environment. A device driver in a server blade may be configured to receive a request to access a shared device from the server blade and to issue a query to a service processor as to whether the requested shared device is being accessed. If the requested shared device is not being accessed by the requesting server blade, then the device driver may wait to receive a response from the service processor indicating that the requested shared device is available. Once the requested device is available, the service processor may connect the requested shared device with the requesting server blade. The request to access the requested shared device may then be transferred to the requested shared device by the server blade.

U.S, Pat. App. Pub. No. 2003/0226004 A1 describes a method and system for storing and configuring CMOS setting information remotely in a server blade environment. The system includes a management module configured to act as a service processor to a data processing configuration.

The patent literature further describes a number of methods for managing the performance of a number of interconnected computer systems. For example, U.S, Pat. App. Pub. No. 2003/0120751 A1 describes a system and method for using free storage capacity on a plurality of storage media as a virtual storage device on a computer network comprising a plurality of computers. A first portion of each storage medium stores data. To implement Virtual Network Attached Storage (VNAS), the respective “free” second portions of each storage medium are aggregated into a shared storage volume. Computers on the network may mount the shared storage volume at one of a plurality of mount points and may store data in the shared storage volume. VNAS may be implemented in a peer-to-peer manner, whereby each computer acts as a server for the data stored on its part of shared storage volume, such as the second portion of the storage media. VNAS may be implemented to implement a system and method for managing data fail-over.

U.S, Pat. App. Pub. No. 2004/0030773 A1 describes a system and method for managing the performance of a system of computer blades in which a management blade, having identified one or more individual blades in a chassis, automatically determines an optimal performance configuration for each of the individual blades and provides information about the determined optimal performance configuration for each of the individual blades to a service manager. Within the service manager, the information about the determined optimal performance configuration is processed, and an individual is set for at least one of the individual blades using the information processed within the service manager.

U.S, Pat. App. Pub. No. 2004/0054780 A1 describes a system and method for automatically allocating computer resources of a rack-and-blade computer assembly. The method includes receiving server performance information from an application server pool disposed in a rack of the rack-and-blade computer assembly, and determining at least one quality of service attribute for the application server pool. If this attribute is below a standard, a server blade is allocated from a free server pool for use by the application server pool. On the other hand, if this attribute is above another standard, at least one server is removed from the server pool.

U.S, Pat. App. Pub. No. 2003/0126260 A1 describes a distributed resource manager for managing resources among a plurality of networked computers, such as computer blades. The resource manager executes on two or more of the computer, e.g. substantially concurrently, collecting data related to usage, performance, status, and/or load, for a component, process, and/or attribute of one or more computers, and evaluating operational rules based on the collected data to determine one or more resource management operations, such as re-configuring, activating/deactivating, and/or switching, and/or swapping computers, for more efficient allocation of resources. Each executing resource manager transmits the determined resource management operations to the other executing resource managers, receives respective determined resource management operations from them, and resolves conflicts between the determined resource management operations and the received respective determined resource management operations, thereby generating a modified one or more resource management operations. The modified resource management operations may be performed with or without human input.

U.S. Pat. No. 6,725,261 describes a system in which various components are provided to manage a clustered environment, in which a number of computer systems are provided with a capability of sharing resources. The components include a System Registry that provides a global data storage, a Configuration Manager that stores data locally on nodes of the clustered environment and globally within the System Registry, a Liveness Component to provide status of communication paths of the cluster, a Group Services Component that provides services to one or more other components of the clustered environment, and a Resources Management Component that communicates with one or more resource controllers of the clustered environment. However, relationships between the components are created such that such that the data and functional dependencies form an acyclic graph, avoiding, for example, a cycle of dependency relationships.

U.S, Pat. App. Pub. No. 2004/0024831 A1 describes a system including a number of server blades, at least two management blades, and a middle interface. The two management blades become a master management blade and a slave management blade, with the master management blade directly controlling the system and with the slave management controller being prepared to control the system. The middle interface installs server blades, switch blades, and the management blades according to an actual request. The system can directly exchange the master management blade and slave management blades by way of application software, with the slave management blade being promoted to master management immediately when the original master management blade fails to work.

U.S, Pat. App. Pub. No. 2003/0226004 A1 describes a method and system for storing and configuring CMOS setting information remotely in a server blade environment. The system includes a management module configured to act as a service processor to a data processing configuration including a set of one or more server blades sharing common resources, such as system power and cooling fans. The management module includes persistent storage in which is stored a table containing CMOS setting information for each server blade in the configuration. Each server blade includes boot block software that executes when the blade is booted after power-on or system reset. The boot block software initiates communication with the management module and retrieves its CMOS settings from the CMOS setting table of the management module. In this manner, CMOS settings for a particular blade location in the configuration remain unchanged each time a blade is replaced or upgraded.

U.S, Pat. App. Pub. No. 2003/0105904 A1 describes a system and method for monitoring server blades in a system that may include a cabinet having a plurality of racks configured to receive a server blade and a management blade configured to monitor service processors within the server blades. Upon installation, a new blade identifies itself by its physical slot position within the cabinet and by blade characteristics needed to uniquely identify and power the blade. The software may then configure a functional boot image on the blade and initiate an installation of an operating system. In response to a power-on or system reset event, the local blade service processor reads slot location and chassis identification information and determines from a tamper lock whether the blade has been removed from the chassis since the last power-on reset. If the tamper latch is broken, indicating that the blade was removed, the local service processor informs the management blade and resets the tamper latch. The local service processor of each blade may send a periodic heartbeat message to the management blade. The management blade monitors the lo0ss of the heartbeat signal from the various local blades, and then is also able to determine when a blade is removed.

What is needed is a method for establishing a user-defined cluster of server blades within a local blade cabinet and one or more remote blade cabinets and for transmitting information read within a local drive unit only to blade servers within the cluster.

### SUMMARY OF THE INVENTION

In accordance with a first aspect of the invention, a method is provided for transmitting information to server blades within a plurality of interconnected blade cabinets, with the method including steps of:

a) accepting a user input from a user interface of a local blade cabinet among the plurality of interconnected blade cabinets, wherein the user input selects a first cluster of server blades within the interconnected blade cabinets;

b) storing information identifying server blades within the first cluster of server blades;

c) reading information from a computer readable medium within a first local drive device of the local blade cabinet; and

d) transmitting the information read in step c) to each server blade within the first cluster of server blades while preventing transmission of the information read in step c) to server blades within the plurality of interconnected blade cabinets and not within the first cluster of server blades.

The method may additionally include, between steps a) and c), transmitting an indication of a hot-plug event to each of the server blades within the local blade cabinet and additionally within the first cluster of server blades. Then, a USB host controller within each server blade within the local cabinet interprets the indication of a hot-plug event as an indication that a first mass storage device has been plugged into a USB network connected to the host controller. Then, in step d) the information is transmitted as information available at the first mass storage device. Furthermore, the method may include receiving a user input selecting a server blade to be deleted from the first cluster and deleting information identifying the server blade to be deleted. Then, an indication of an unplug event is transmitted to the server blade to be deleted.

### BRIEF DESCRIPTION OF THE FIGURES

FIG. 1 is a block diagram of a system configured in accordance with the invention;

FIG. 2 is a block diagram of a server blade within a blade cabinet in the system of FIG. 1;

FIG. 3 is a block diagram of data and instruction storage in a management system within a blade cabinet in the system of FIG. 1;

FIG. 4 shows a menu screen displayed during the execution of a program in accordance with a first embodiment of the invention within the system of FIG. 1;

FIG. 5 shows a dialog box displayed for adding a server blade to a user-defined cluster during execution of a program in accordance with the invention within the system of FIG. 1;

FIG. 6 shows a dialog box displayed for deleting a server blade from the user-defined cluster during execution of a program in accordance with the invention within the system of FIG. 1;

FIG. 7, which is divided into an upper portion, indicated as FIG. 7A, and a lower portion, indicated as FIG. 7B, is a flow chart showing process steps occurring during execution of the program in accordance with the invention within the system of FIG. 1.

FIG. 8 shows a menu screen displayed during the execution of a program in accordance with a second embodiment of the invention within the system of FIG. 1;

FIG. 9 shows a dialog box displayed during the loading of data to a user-defined cluster during execution of the program in accordance with the second version of the invention within the system of FIG. 1;

FIG. 10 is a block diagram showing an alternate arrangement for transmitting data to server blades in accordance with the invention; and

FIG. 11 is a block diagram of a server blade within the alternate arrangement of FIG. 10.

### DETAILED DESCRIPTION OF THE INVENTION

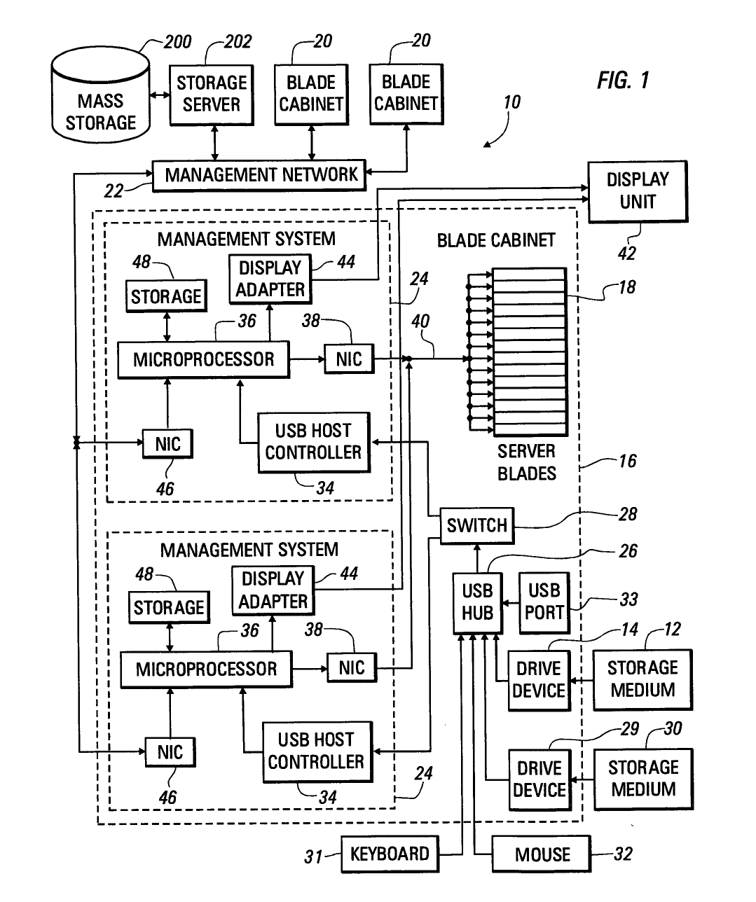

FIG. 1 is a block diagram of a system 10 configured in accordance with the invention to provide for the transmission of information, such as data and program instructions, from a data storage medium 12 read within a first local drive device 14, to a user-defined cluster of computer systems. The first local drive device 14 is housed within a local blade cabinet 16 additionally including a number of server blades 18, which is attached to one or more additional remote blade cabinets 20 through a management network 22, which is, for example, an Ethernet network. For example, the blade cabinets 16, 20 each comprise an IBM BladeCenter™, each of which includes fourteen slots or positions in which the server blades 18 may be installed in a manner allowing their subsequent removal. The user-defined cluster of computer systems may include one or more of the server blades 18 within the local blade cabinet 16 and one or more server blades (not shown) within the additional remote blade cabinets 20. For example, the storage medium 12 is an optical disk, with the first local drive device 14 being an optical disk reader.

The transmission of information between the first local drive device 14 and the server blades 18 within the local blade cabinet 16 is controlled by either one of a pair of local management systems 24 within the local blade cabinet 16. Two such systems 24 are included to provide redundancy, so that operations can continue in the event that one of the systems 24 fails. Program means are provided to transfer stored information between the systems 24 and to determine when one of the systems 24 fails and to then switch operations to the other system 24. For example, the local management systems 24 may be switched as described in U.S, Pat. App. Pub. No. 2004/0024831 A1, the disclosure of which is hereby incorporated by reference. The output of the first local drive device 14 is provided as an input to a USB (Universal Serial Bus) hub 26, which in turn provides an input to a switch 28. The switch 28 directs inputs to the management computer system 24 that is presently operational.

Optionally, a second local drive device 29 is also provided as an input to the USB hub 26, providing a means for reading data from an additional data storage medium 30, which may be the same type of data storage medium as the data storage medium 12 or a different type of data storage medium, such as a magnetically recorded data storage medium. A keyboard 31 and a pointing device 32, such as a mouse, also provide inputs to the USB hub 26. Each of the management computer systems 24 includes a USB host controller 34 transmitting inputs from the switch 28 to a microprocessor 36, which is additionally connected to each of the server blades 18 through a network interface circuit 38 and a local internal network 40, which is, for example, an Ethernet network. The microprocessor 36 is additionally connected to a display unit 42 through a display adapter 44 and to the management network 22 through a network interface circuit 46. The keyboard 31, mouse 32, and display unit 42 comprise a local user interface of the local blade cabinet 42. Each of the management computer systems includes data and instruction storage 48.

The microprocessor 36 in the operating local management system 24 executes an operating system, such as a version of Linux, that provides a USB-awareness feature, so that the drive devices 14, 29 appear as a standard mass-storage devices to the microprocessor 36, with the management computer system 24 therefore being able to perform any operation on the drive devices 14, 29 needed to read data from the storage media 12, 30.

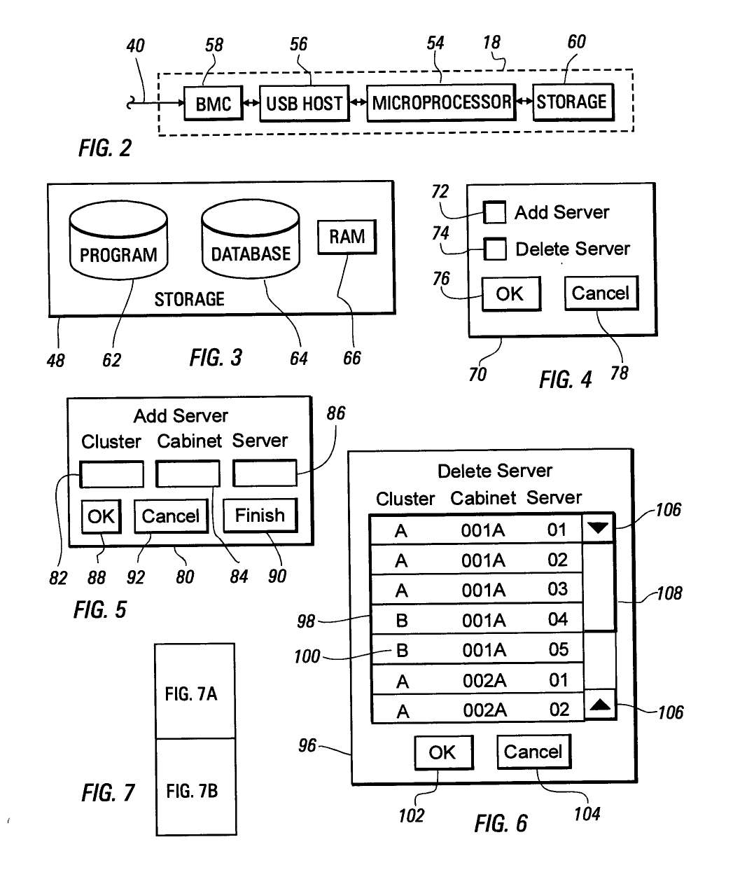

FIG. 2 is a block diagram of one of the server blades 18 within the blade cabinets 16, 20 in the system 10. The server blade 18 includes a microprocessor 54 connected to the local internal network 40 through a USB host controller 56 and through a BMC 58 (baseboard management controller) within the server blade 18. The BMC 58 performs the conversions required between the local internal network 40, which operates with Ethernet protocols, and the connection to the USB host controller 56, which uses the USB protocol. The server blade 18 additionally includes data and instruction storage 60.

FIG. 3 is a block diagram of the data and instruction storage 48 within each of the local management systems 24. The data and instruction storage 48 includes stored instructions for a program 62 to be executed within the microprocessor 36 in accordance with the invention to provide a user interface for establishing at least one user-defined cluster of server blades 18 and to provide for the transfer of information from the first local drive device 14 to each server blade 18 within such a cluster. The data and instruction storage 48 further includes a database 64, holding data identifying the server blades 18 within the user-defined cluster(s), and a random access memory 66 in which instructions are loaded for execution within the microprocessor 36. Programs to be executed within the microprocessor 36, including the program 62, may be loaded into storage 48 by means of computer readable media storing instructions for such programs, inserted into the drive device 14, 21, or by means of a computer data signal embodied on a carrier wave transmitted along the management network 22.

In accordance with a preferred version of the present invention, the characteristics of the USB interface are used to advantage in transmitting data from a single first local drive device 14, 29 to each of the server blades 18 within a cluster. The program 62 executing within the operational local management system 24 emulates a mass storage device connected to a USB bus for each user-defined cluster including one or more blades within the local blade cabinet 16. When a server blade 18 is added to a cluster, the program 62 transmits a code representing a hot-plug event to the server blade, so that the USB host 56 within the server blade 18 begins polling the emulated mass storage device to determine if data is available. When data is being read through the first local drive device 14, 29, the program 62 emulates this data as becoming available from the emulated mass storage device, so that this data is read through the USB host 56. When a server blade 18 within the local blade cabinet 16 is subsequently deleted from the cluster, the program 62 transmits a code representing an unplug event to the server blade 18, so that the USB host 56 within the server blade 18 stops polling the emulated mass storage device, from which data is no longer accepted by the server blade 18.

FIG. 4 shows a menu screen 70 displayed on the display unit 42 during execution of the program 62, with selections being made by the user, using the mouse 32 as a selection device. The menu screen 70 includes an “Add” check box 72, which is selected by the user to indicate a desire to add a server blade 18 to a cluster of server blades 18 to which data will be transmitted from one of the drive devices 14, 29. The menu screen 70 additionally includes a “Delete” check box 74, which is selected by the user to indicate a desire to delete such a server blade 18 from a cluster. Preferably, when one of the check boxes 72, 74 is selected, a check mark is placed within the selected box 72, 74, while a check mark is removed from the other box, if it is present. When the user is satisfied that he is ready to proceed, he selects the “ok” command button 76. If he decides not to proceed, he selects the “cancel” command button 78.

FIG. 5 shows an “Add Server” dialog box 80, which is displayed on the display unit 42 in response to completing the use of the menu screen 70 with the “add” check box 72 selected. The dialog box 80 includes three text boxes 82, 84, 86, in which data is entered using the keyboard 31 following the selection of each individual text box 82 with the mouse 32. The first text box 82 is used to specify the cluster to which a server blade 18 is to be added. In accordance with the first embodiment of the invention, the cluster identifies the first local drive device 14, 29 from which data will be transmitted to the server blades 18 within the cluster. For example, the first first local drive device 14 and the first cluster may both be identified by the letter “A,” while the second local drive device 29 and the second cluster are identified by the letter “B.” The second text box 84 is used to enter an identifier of the local blade cabinet 16, 20 holding the server blade 18 being added. The third text box 86 is used to enter an identifier of the particular server blade being added. This identifier may be derived from a number associated with the removable blade 18 or with the slot position within the cabinet 16, 20 in which the server blade 18 is held.

Preferably, the “Add Server” dialog box 80 can be used to add a number of server blades 18 to one or more clusters without returning to the menu screen 70. Thus, the user, being satisfied that he has properly filled in the text boxes 82, 84, 86, selects the “OK” command button 88 if he has another server blade 18 to add to a cluster, causing the information within the text boxes 82, 84, 86 to be stored and erased from these boxes 82, 84, 86, with the dialog box 80 still being displayed for the entry of data describing another server blade 18. On the other hand, if data describing the only server blade 18 to be added, or the last server blade 18 in a number of server blades 18 being added, the user selects the “Finish” command button 90 is selected, causing the data in the text boxes 82, 84, 86 to be saved as the process of displaying the dialog box 80 is ended. If the “Cancel” command button 92 is selected, the process of displaying the dialog box 80 is terminated without saving data written to the text boxes 82, 84, 86.

FIG. 6 shows a “Delete Server” dialog box 96, which is displayed on the display unit 42 in response to completing the use of the menu screen 70 with the “Delete” check box 74 selected. The dialog box 96 includes a list box 98 having an entry 100 for each server blade 18 that has previously been included in a cluster. The data displayed in each entry 100 identifies the cluster, the local blade cabinet 16, 20 holding the server blade, and the server blade 18 itself. The user selects an entry 100 for deletion by clicking on it with the mouse 32, causing this entry 100 to appear highlighted. This action toggles, so that an improper choice can be reversed by clicking on the entry a second time. Multiple entries 100 can be deleted in this way. When the selection of entries for deletion has been completed, the user selects the “OK” command button, causing data describing the selected entries to be stored for modification of data defining the clusters, along with an end of the display of the dialog box 96. If the “Cancel” command button 104 is selected, the display of the dialog box 96 is ended without causing the modification of cluster data. If the list of server blades 18 within identified clusters is too long to be shown in the list box 98, arrow buttons 106 and a slider 108 are provided to facilitate viewing and selecting individual portions of the list.

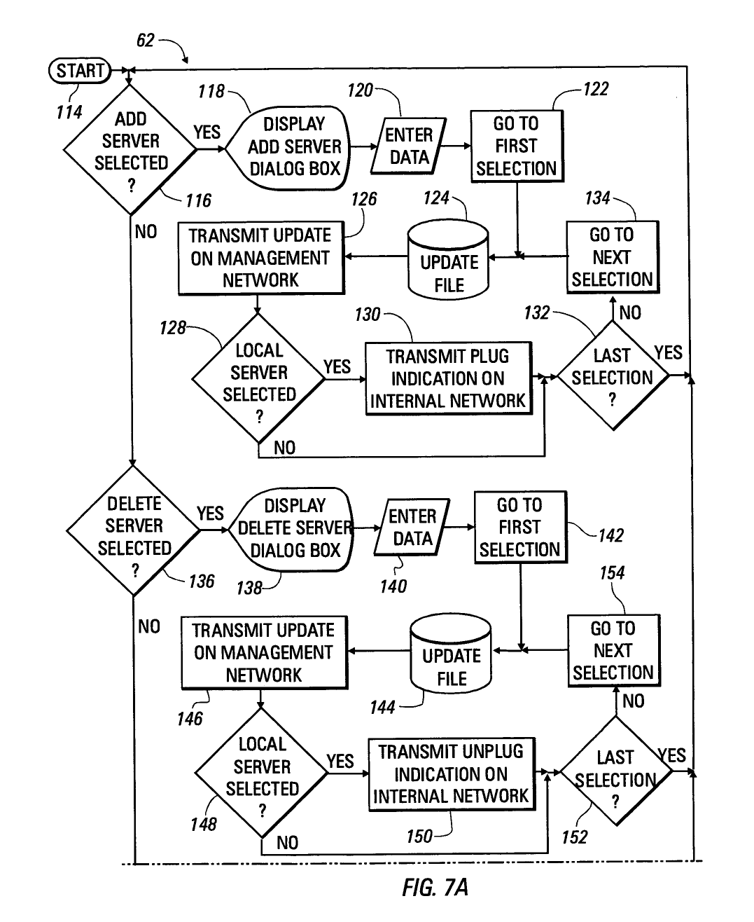

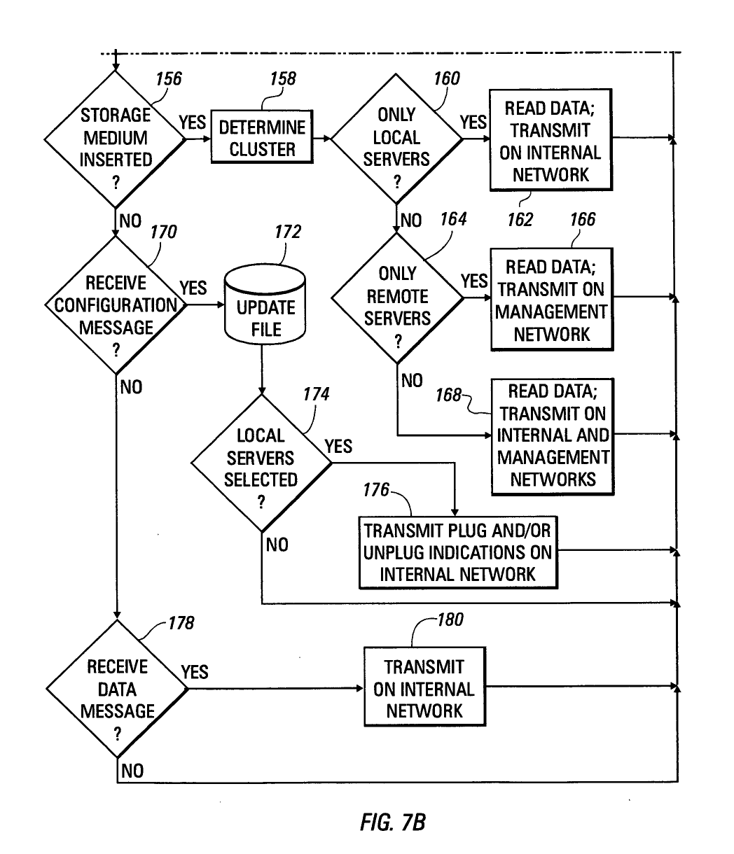

FIG. 7, which is divided into an upper portion, indicated as FIG. 7A, and a lower portion, indicated as FIG. 7B, is a flow chart showing process steps occurring during execution, in accordance with the invention, of the program 62, having instruction steps stored within the instruction and data storage 48 of each local management system 24. Preferably, the program runs at least in the background of a multitasking environment whenever the local blade cabinet 16 is operational, being available to receive data transmitted over the management network 22 from other remote blade cabinets 20, with at least an icon that can be selected to cause the display of the menu described above in reference to FIG. 4.

After starting in step 114, the program 62 responds to selections from the menu screen 70, to the insertion of a storage medium into either of the drive devices 14, 29, and to receiving a message over the management network 22, proceeding first to step 116, in which it is determined whether the “Add” check box 72 of the menu screen 70 has been selected. If it has, the “Add Server” dialog box 80 is displayed in step 118, with data entry in step 120 then proceeding as described above in reference to FIG. 5. In general, one or more server blades 18 are selected by the user to be added to one or more clusters, with the data entry step 120 being ended by the selection of the “Finish” command button 90. Then, in step 122, the program 62 proceeds to consider the first of these selections, with the file stored in the database 64 within data and instruction storage 48 of the local management system 24 being updated in step 124 to reflect a new server blade 18 in the designated cluster.

In accordance with a preferred version of the invention, the local management systems 24 in each of the blade cabinets 16, 20 includes a database 64 storing information identifying each of the server blades 18 in each of the clusters. Thus, in step 126, information identifying the server blade 18 being added to a cluster is transmitted on the management network 22 to the other remote blade cabinets 20. Next, in step 128, a determination is made of whether the server blade 18 being added to a cluster is a local server blade 18, held within the local blade cabinet 16. If it is, a hot-plug indication is transmitted in step 130 from the local internal network 40 to the server blade 18 being added. This action causes the USB host controller 58 within this server blade 18 to begin polling a mass storage device emulated by the program 62 for data. Next, in step 132, a further determination is made of whether the selection of a server blade to add to a cluster that has just been considered is the last selection that has been made with the “Add Server” dialog box 80. If it is not, the program 62 proceeds to step 134 to consider the next selection; otherwise, the program 62 returns to step 116.

When it is determined in step 116 that the “Add” check box 72 of the menu 70 has not been selected, the program 16 proceeds to step 136, in which a further determination is made of whether the “Delete” check box 74 has been selected. If it has, the “Delete Server” dialog box 96 is displayed in step 138, with data entry in step 140 then proceeding as described above in reference to FIG. 6. In general, one or more server blades 18 are selected by the user to be deleted from one or more clusters, with the data entry step 140 being ended by the selection of the “OK” command button 102. Then, in step 142, the program 62 proceeds to consider the first of these selections, with the file stored in the database 64 within data and instruction storage 48 of the local management system 24 being updated in step 144 to reflect the deletion of a server blade 18 in the designated cluster. Then, in step 146, information identifying the server blade 18 being deleted from a cluster is transmitted on the management network 22 to the other remote blade cabinets 20. Next, in step 148, a determination is made of whether the server blade 18 being deleted from a cluster is a local server blade 18, held within the local blade cabinet 16. If it is, an unplug indication is transmitted in step 150 from the local internal network 40 to the server blade 18 being deleted. This action causes the USB host controller 58 within this server blade 18 to no longer poll the mass storage device emulated by the program 62 for data. Next, in step 152, a further determination is made of whether the selection of a server blade to delete from a cluster that has just been considered is the last selection that has been made with the “Delete Server” dialog box 96. If it is not, the program 62 proceeds to step 154 to consider the next selection; otherwise, the program 62 returns to step 116.

When it is determined in step 136 that the “Delete” check box 74 has not been checked, the program 62 proceeds to step 156, in which a further determination is made of whether the storage medium 12, 30 has just been inserted within one of the drive devices 14, 29 to load data to a cluster of server blades 18. If it has, the cluster of server blades 18 to which data is to be loaded is determined in step 158. In accordance with the first embodiment of the invention, this determination is based on which of the drive devices 14, 29 is being used. Then, in step 160, a determination is made of whether only local server blades 18, within the local blade cabinet 16, are within the cluster identified in step 158. If only such local server blades 18 are in the cluster, the data read from the storage medium 12, 30 is transmitted in step 162 to these local server blades 18 on the local internal network 40. On the other hand, if a determination is made in step 160 that the information is to be transmitted not only to local server blades 18 in the local blade cabinet 16, a further determination is made in step 164 of whether the information is to be transmitted only to remote server blades 18 within the remote blade cabinets 20. If it is, the information is transmitted in step 162 to the remote server blades 16 in the cluster over the management network 22. Since step 164 is preceded by a determination in step 160 that information is not to be transmitted only to local server blades 18, a determination in step 164 that information is not to be transmitted only to remote server blades 18, indicates that the information must be transmitted to both local and remote server blades 18. Therefore, in the event that such a determination is made, the program 62 proceeds to step 168, in which in which the information is transmitted to the server blades 18 within the cluster over both the local internal network 40 and the management network 22. This sequence allows information to be transferred as required as the storage medium 12, 30 is read only once. When the transmission of data in step 162, 166, or 168 has been completed, the program 62 returns to step 116.

When information is to be transmitted over the local internal network 40 in step 162 or in step 168, the program 62 emulates the presence of a disk within the mass storage device being emulated to transmit data to the cluster of server blades 18. The server blades 18 within the cluster poll this emulated storage device on a regular basis, to detect the presence of the disk and receive the data.

On the other hand, when it is determined in step 156 that the storage medium 12, 30 has not been just inserted in one of the drive devices 14, 29, the program 62 proceeds to step 170, in which an additional determination is made of whether a configuration message has been received from the management network 22. Such a message would indicate that a user is adding one or more server blades 18 to one or more clusters, or deleting one or more server blades 18 therefrom, using one of the remote cabinets 20. If it is determined in step 170 that such a message has been received, the database 64 is updated in step 172 to reflect the new information. Then, an additional determination is made in step 174 of whether local server blades 18, within the local blade cabinet 16, are involved in the configurational changes. If they are, in step 176, indications that the mass storage device being emulated for the cluster in which the changes are occurring has been hot-plugged are transmitted to any local server blade 18 being added to the cluster, while indications that this emulated mass storage device has been unplugged are transmitted to any local server blade 18 being deleted from the cluster. Then the program 62 returns to step 116.

When it is determined in step 170 that a configuration message has not been received from the management network 22, the program 62 proceeds to step 178, in which a further determination is made of whether a data message is being received. Such a message would indicate that a user is loading data to one or more server blades 18 within the local blade cabinet 16 from one of the remote cabinets 20. Thus, if such a message is received, the program 62 causes the emulated mass storage device associated with the cluster to appear to have a disk present, so that the server blades 18 within the local blade cabinet 16, polling this device will accept the data as it is transmitted to them over the local internal network 40 in step 189.

As described above, in accordance with the first embodiment of the invention, the system 10 includes one or more clusters of server blades 18, with data from a storage medium 12, 30 being transferred to each of the server blades 18 within a cluster according to the first local drive device 14, 29 into which the storage medium 12, 30 is inserted. For example, the first embodiment of a the invention is understood to include a system having only a single first local drive device 14 and a single cluster of server blades 18 into which information is loaded. Furthermore, this first embodiment of the invention is understood to alternately include three or more drive devices 14, 29 for transmitting data to three or more corresponding clusters of server blades 18.

In accordance with a preferred version of the invention, the remote blade cabinets 20 are understood to include elements similar to those that have been described in detail as associated with the local blade cabinet 16. For example, each of the remote blade cabinets 20 is understood to include a number of remote server blades corresponding to the local server blades 18 within the local blade cabinet 16, a first and second remote management systems corresponding to the first and second local management systems 24 of the local blade cabinet 16, a remote internal network corresponding to the local internal network 40, and a remote user interface including a keyboard, mouse, and display unit. Preferably, the remote management systems in the remote blade cabinets 20 execute a program as described above in reference to FIG. 7, so that the remote user interfaces may be used to add server blades 18 within the remote blade cabinets 20 and within the local blade cabinet 16 to user-defined clusters, and to delete such server blades 18 therefrom, and so that remote drive units within the remote blade cabinets 20 may be used to transmit data to server blades 18 within such clusters. Alternately, the system 10 may be arranged to provide for such user actions only from the local blade center 16, with server blades 18 within the remote blade cabinets 20 being included in clusters defined by user actions at the local blade center 16, and with data being transmitted to server blades 18 in the remote blade cabinets 20 from the local blade center 16.

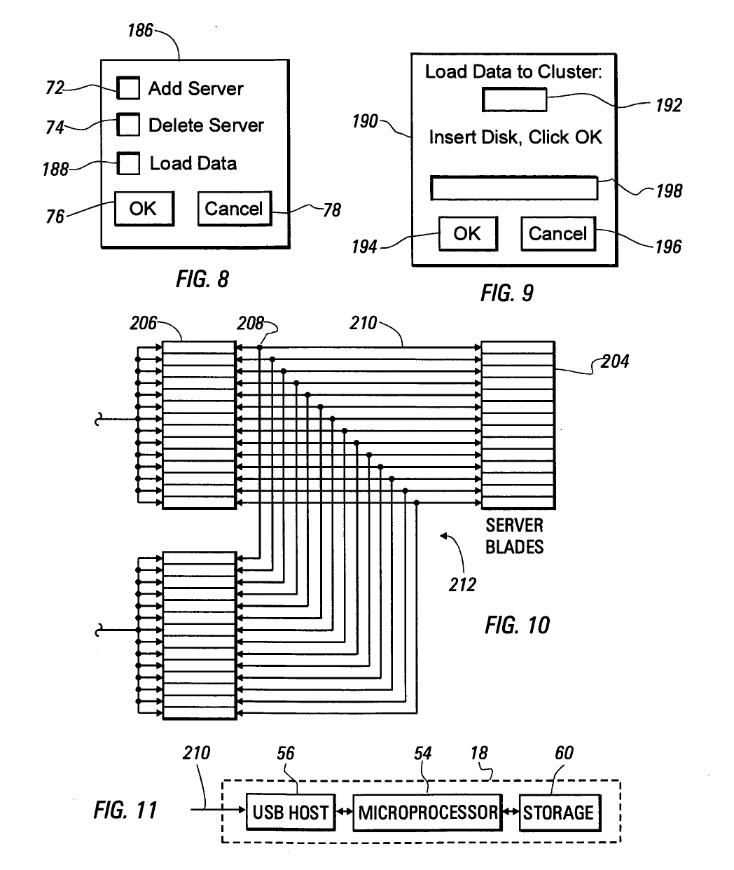

In accordance with a second embodiment of the invention, the system 10 includes a single first local drive device 14 and two or more clusters of server blades 18, to which data is transferred from the single first local drive device 14 according to a selection of a cluster by the user. FIGS. 8 and 9 show exemplary display screens presented during operation of the system in accordance with the second embodiment of the invention.

FIG. 8 shows a menu screen 186 displayed on the display device 42 during operation of the system 10 in accordance with the second embodiment of the invention. This menu screen 186 is similar to the menu screen 70 of the first embodiment, described above in reference to FIG. 4, including an “Add Server” check box 72, a “Delete Server” check box 74, an “OK” command button 76, and a “Cancel” command button 78, all of which are used as described above, and which are therefore accorded like reference numbers. The menu screen 186 additionally includes a “Load Data” check box 188, which is used to begin a process of loading data from a single first local drive device 14 to one of a number of user-defined clusters of server blades 18.

FIG. 9 shows a dialog box 190 displayed, in response to the selection of the “Load Data” check box 188 of the menu screen 186, during the loading of data to a user-defined cluster as the system 10 is operated in accordance with the second embodiment of the invention. This dialog box 190 includes a text box 192, in which information identifying the cluster of server blades 18 displayed as it is typed by the user through the keyboard 31. When the user is satisfied that he has correctly entered this information, he selects the “OK” command button 194, starting the process of loading data from the first local drive device 14 to the chosen cluster of server blades 18. Alternately, if the user selects the “Cancel” command button 196, the dialog box 190 is closed without beginning an information loading process. The dialog box 190 may also include a box 198 in which a segmented bar is displayed to indicate the proportion of the data downloading process that has occurred.

Operation of the program 62 according to the second embodiment of the invention is generally as described above in reference to FIG. 7, except that, in step 158, the determination of the cluster of server blades 18 to which information will be loaded is based not upon the first local drive device 14, 29 in which the storage medium 12, 30 has just been inserted, but rather upon information added to the text box 192 by the user.

FIG. 10 is a block diagram showing an alternate arrangement for transmitting data to a number of server blades 204 in accordance with the invention. In this alternative arrangement, the network interface circuit 38 (shown in FIG. 1) in each of the local management systems 24 is replaced with fourteen virtual USB devices 206, each of which is connected to receive data from the microprocessor 36 within the management system 24 and to transmit data to a server blade 204 through a USB hub 208 and a USB channel 210. For example, each of the virtual USB devices 206 is emulated using a Cypress FX2 device part.

FIG. 11 is a block diagram of one of the server blades 204, showing the USB host controller 56 connected to the USB channel 210. These connections are made to all of the server blades 204, so that the USB host controllers 56 poll the virtual devices 206 on a regular basis, regardless of whether the particular server blade 204 is in a user-defined cluster, with each of the virtual devices 206 appearing as a mass-storage device to the associated USB host controller 56. However, the microprocessor 36 is programmed to transmit data only to those virtual devices 206 that are connected to server blades 204 within a user-defined cluster of the server blades 204 to which data is to be transmitted. Server blades 204 not within such a cluster see their associated virtual devices 206 as mass storage devices without media. Operation of the system with the alternative arrangement of FIGS. 10 and 11 is as described above in reference to FIG. 7, with the USB channels 210 forming an internal network 212 over which data is transmitted to the server blades 204 in steps 162 and 168.

While the invention has been described in terms of the execution of a program 62 stored within data and instruction storage 48 of each management system 22, and in terms of using a database 64 additionally stored within the data and instruction storage 48 of each management system 22, it is understood that either or both of the program 62 and the database 64 may alternatively be located elsewhere within the system 10. For example, as shown in FIG. 1, the program 62 and the database 64 may be stored in mass storage 200 connected to a storage server 202, to be accessed by each of the local management systems 24 through the management network 22.

It is further understood that the system 10 may be arranged so that only one of the blade cabinets, such as local blade cabinet 16, can be used to transmit data it its local server blades 18, and to server blades 18 within the remote blade centers 20.

While the invention has been described in its preferred versions or embodiments with some degree of particularity, it is understood that this description has been given only by way of example, and that many variations can be achieved without departing from the spirit and scope of the invention, as defined within the appended claims.

What is claimed is:

1. A method for transmitting information to server blades within a plurality of interconnected blade cabinets, wherein the method comprises steps of:
a) accepting a user input from a user interface of a local blade cabinet among the plurality of interconnected blade cabinets, wherein the user input selects a first cluster of server blades within the interconnected blade cabinets;
b) storing information identifying server blades within the first cluster of server blades;
c) reading information from a computer readable medium within a first local drive device of the local blade cabinet; and
d) transmitting the information read in step c) to each server blade within the first cluster of server blades while preventing transmission of the information read in step c) to server blades within the plurality of interconnected blade cabinets and not within the first cluster of server blades.

2. The method of claim 1, wherein
the first cluster of server blades includes at least one server blade within the local blade cabinet and at least one server blade within a remote blade cabinet within the plurality of interconnected blade cabinets, and
the information is transmitted to at least one server blade within the local server through a local internal network within the local blade cabinet and to at least one server blade within the remote blade cabinet through a management network connecting the interconnected blade cabinets and through a remote internal network within the remote blade cabinet.

3. The method of claim 1, wherein
the method additionally includes, between steps a) and c), transmitting an indication of a hot-plug event to each of the server blades within the local blade cabinet and within the first cluster of server blades,
a USB host controller within each server blade within the local blade cabinet interprets the indication of a hot-plug event as an indication that a first mass storage device has been plugged into a USB network connected to the USB host controller, and
in step d), the information is transmitted as information available at the first mass storage device.

4. The method of claim 1, wherein, in step d), the information is transmitted to a virtual USB device emulated within a device part within the local blade cabinet connected to a USB host controller within each server blade within the local blade cabinet and within the first cluster of server blades.

5. The method of claim 1, additionally comprising steps of:
e) receiving information within the local blade cabinet transmitted from a remote blade cabinet through a management network interconnecting the blade cabinets; and
f) transmitting the information received in step e) to each server blade within the first cluster of server blades and within the local blade cabinet, while preventing the transmission of the information received in step e) to each server blade within the local blade cabinet and not within the first cluster of server blades.

6. The method of claim 1, additionally comprising steps of:
e) receiving a user input from the user interface of the local blade cabinet selecting a server blade to be deleted from the first cluster of server blades; and
f) deleting information identifying the server blade to be deleted from the information stored in step b).

7. The method of claim 6, wherein
the method additionally includes, between steps a) and c), transmitting an indication of a hot-plug event to each of the server blades within the local blade cabinet and within the first cluster of server blades,
a USB host controller within each server blade within the local blade cabinet interprets the indication of a hot-plug event as an indication that a first mass storage device has been plugged into a USB network connected to the USB host controller,
in step d), the information is transmitted as information available at the first mass storage device,
the method additionally includes, following step e), transmitting an unplug event to the server blade to be deleted, and
the USB host controller within each server blade within the local blade cabinet interprets the unplug indication as an indication that a first mass storage device has been unplugged from the USB network connected to the USB host controller.

8. The method of claim 1, additionally comprising steps of:
e) accepting a user input from the user interface selecting a second cluster of server blades within the interconnected blade cabinets;
f) storing information identifying server blades within the second cluster of server blades;
g) reading information from a computer readable medium within a second local drive device of the local blade cabinet; and
h) transmitting the information read in step g) to each server blade within the second cluster of server blades while preventing transmission of the information read in step g) to server blades within the plurality of interconnected blade cabinets and not within the first cluster of server blades.

9. The method of claim 1, additionally comprising steps of
e) accepting a user input from the user interface selecting a second cluster of server blades within the interconnected blade cabinets;
f) storing information identifying server blades within the second cluster of server blades;
g) accepting a user input from the user interface indicating that information is to be transmitted to server blades within the second cluster of server blades; and
h) in response to step g), transmitting information to each server blade within the second cluster of server blades while preventing transmission of the information read in step g) to server blades within the plurality of interconnected blade cabinets and not within the first cluster of server blades.

10. A system comprising:
a local blade cabinet including a local group of server blades, a first local management system having a local user interface, a first local drive device for reading computer readable information from a removable storage medium, and a local internal network connecting the first local management system to each server within the local group of server blades;
a remote cabinet including a remote group of server blades;
a management network connecting the first local management system with the remote cabinet; and
a microprocessor within the first local management system programmed to receive inputs from the local user interface selecting at least one of the server blades within the local and remote groups of server blades to be included in a first cluster, to store data identifying the at least one server blade selected to be within the first cluster, and to transmit information read through the first local drive device to the server blades in the first cluster while preventing transmission of information to server blades not in the first cluster, wherein the information read through the first drive is transmitted to server blades in the local group through the local internal network and to server blades in the remote group through the management network.

11. The system of claim 10, wherein
each server blade in the local group of server blades includes a USB host controller,
the microprocessor within the first local management system is programmed to transmit a hot-plug indication to each server blade within the local group of server blades selected to be within the first cluster,
the USB host controller within each server blade in the local group of server blades interprets the hot-plug indication as an indication that a first mass storage device has been plugged into a USB network connected to the USB host controller, and
the microprocessor within the first local management system is additionally programmed to transmit the information read through the first local drive device as information available at the first mass storage device.

12. The system of claim 11, wherein
the microprocessor in the first local management system is additionally programmed to receive an input from the local user interface selecting at least one of the server blades within the first cluster to be deleted from the first cluster, to modify stored data identifying the at least one of the server blades to be deleted as being within the first cluster, and to transmit an unplug indication to each of the server blades within the first cluster selected to be deleted from the first cluster, and
the USB host controller within a server blade in the local group of server blades interprets the unplug indication as an indication that the first mass storage device has been unplugged from the USB network connected to the USB host controller.

13. The system of claim 10, wherein
each server blade in the local group of server blades includes a USB host controller,
the first local management system additionally includes a virtual USB device emulated within a device part connected to each USB host controller, and
the microprocessor within the first local management system is programmed to transmit information read through the first drive to each device parts connected to a USB host controller within a server blade identified by the stored data as being within the first cluster.

14. The system of claim 13, wherein the microprocessor in the first local management system is additionally programmed to receive an input from the local user interface selecting at least one of the server blades within the first cluster to be deleted from the first cluster, and to modify stored data identifying the at least one of the server blades to be deleted as being within the first cluster,

15. The system of claim 10, wherein the microprocessor in the first local management system is additionally programmed to receive an input from the local user interface selecting at least one of the server blades within the first cluster to be deleted from the first cluster, to modify stored data identifying the at least one of the server blades as being within the first cluster, and to prevent subsequent transmission of information read through the first drive to the at least one of the server blades.

16. The system of claim 10, wherein
the first local management system additionally has a second local drive device for reading computer readable information from a computer readable medium, and
the microprocessor within the first local management system is additionally programmed to receive inputs from the local user interface selecting at least one of the server blades within the local and remote groups of server blades to be included in a second cluster, to store data identifying the at least one server blade selected to be within the second cluster, and to transmit information read through the second local drive device to the server blades in the second cluster while preventing transmission of information to server blades not in the second cluster, wherein the information read through the second drive is transmitted to server blades in the local group through the local internal network and to server blades in the remote group through the management network.

17. The system of claim 10, wherein the first local management system is additionally programmed to:
receive inputs from the local user interface selecting at least one of the server blades within the local and remote groups of server blades to be included in a second cluster, to store data identifying the at least one server blade selected to be within the second cluster;
receive a cluster selection input from the local user interface indicating a cluster to which data is to be transmitted;
transmit information read through the first local drive device to the server blades in the first cluster in response to receiving the cluster selection input identifying the first cluster, and
transmit information read through the first local drive device to the server blades in the second cluster in response to receiving the cluster selection input identifying the second cluster.

18. The system of claim 10, additionally comprising:
a first remote management system having a remote user interface and a first remote drive device for reading computer readable information from a removable storage medium, wherein the remote group of server blades are connected to the management network through the first remote management system,
a remote internal network connecting the first remote management system to each computer within the remote group of server blades, and
a microprocessor within the first remote management system programmed to receive inputs from the remote user interface selecting at least one of the server blades within the local and remote groups of server blades to be included in the first cluster, to store data identifying the at least one of the server blades within the local and remote groups of server blades selected to be within the first cluster while preventing transmission of information to server blades not within the first cluster, wherein information read through the first local drive is transmitted to server blades in the remote group through the management network and the remote internal network.

19. The system of claim 18, wherein
each server blade in the local and remote groups of server blades includes a USB host controller,
the microprocessor within the first local management system is programmed to transmit a hot-plug indication to each server blade within the local group of server blade selected to be within the first cluster,
the microprocessor within the first remote management system is programmed to transmit a hot-plug indication to each server blade within the remote group of server blade selected to be within the first cluster,
the USB host controller within each server blade in the local and remote groups of server blades interprets the hot-plug indication as an indication that a first mass storage device has been plugged into a USB network connected to the USB host controller;
the microprocessor within the first local management system is additionally programmed to transmit the information read through the first local drive device as information available at the first mass storage device; and
the microprocessor within the first remote management system is additionally programmed to transmit the information read through the first local drive device as information available at the first mass storage device.

20. The system of claim 11, wherein
the microprocessor in the first local management system is additionally programmed to receive an input from the local user interface selecting at least one of the server blades within the first cluster to be deleted from the first cluster, to modify stored data identifying the at least one of the server blades to be deleted as being within the first cluster, and to transmit an unplug indication to each of the local server blades within the first cluster selected to be deleted from the first cluster,
the microprocessor in the first remote management system is additionally programmed to receive an input from management network selecting at least one of the server blades within the first cluster to be deleted from the first cluster, to modify stored data identifying the at least one of the server blades to be deleted as being within the first cluster, and to transmit an unplug indication to each of the remote server blades within the first cluster selected to be deleted from the first cluster; and
each USB host controller within a server blade in the local and remote groups of server blades interprets the unplug indication as an indication that the first mass storage device has been unplugged from the USB network connected to the USB host controller.

21. The system of claim 10, wherein the local blade cabinet additionally includes:
a second local management system having a microprocessor programmed to receive inputs from the local user interface selecting at least one of the server blades within the local and remote groups of server blades to be included in a first cluster, to store data identifying the at least one server blade selected to be within the first cluster, and to transmit information read through the first local drive device to the server blades in the first cluster while preventing transmission of information to server blades not in the first cluster, wherein the information read through the first drive is transmitted to server blades in the local group through the local internal network and to server blades in the remote group through the management network, and
program means to transfer data stored within each of the local management systems to the other local management system, to determine when either of the local management systems fails, and to transfer operation of the local blade cabinet from the local management system that has failed to the other local management system.

22. A computer readable medium storing code for a program causing a management computer system within a blade cabinet to perform a method for transmitting information to server blades within a plurality of interconnected blade cabinets, wherein the method comprises steps of:
a) accepting a user input from a user interface of a local blade cabinet among the plurality of interconnected blade cabinets, wherein the user input selects a first cluster of server blades within the interconnected blade cabinets;
b) storing information identifying server blades within the first cluster of server blades;
c) reading information from a computer readable medium within a first local drive device of the local blade cabinet; and
d) transmitting the information read in step c) to each server blade within the first cluster of server blades while preventing transmission of the information read in step c) to server blades within the plurality of interconnected blade cabinets and not within the first cluster of server blades.

23. The computer readable medium of claim 22, wherein
the first cluster of server blades includes at least one server blade within the local blade cabinet and at least one server blade within a remote blade cabinet within the plurality of interconnected blade cabinets, and
the information is transmitted to at least one server blade within the local server through a local internal network within the local blade cabinet and to at least one server blade within the remote blade cabinet through a management network connecting the interconnected blade cabinets and through a remote internal network within the remote blade cabinet.

24. The computer readable medium of claim 22, wherein
the method additionally includes, between steps a) and c), transmitting an indication of a hot-plug event to each of the server blades within the local blade cabinet and within the first cluster of server blades,
a USB host controller within each server blade within the local blade cabinet interprets the hot-plug indication as an indication that a first mass storage device has been plugged into a USB network connected to the USB host controller, and
in step d), the information is transmitted as information available at the first mass storage device.

25. The computer readable medium of claim 22, wherein, in step d), the information is transmitted to a virtual USB device emulated within a device part within the local blade cabinet connected to a USB host controller within each server blade within the local blade cabinet and within the first cluster of server blades.

26. The computer readable medium of claim 22, wherein the method additionally comprises steps of:
e) receiving information within the local blade cabinet transmitted from a remote blade cabinet through a management network interconnecting the blade cabinets; and
f) transmitting the information received in step e) to each server blade within the first cluster of server blades and within the local blade cabinet, while preventing the transmission of the information received in step e) to each server blade within the local blade cabinet and not within the first cluster of server blades.

27. The computer readable medium of claim 22, wherein the method additionally comprises steps of:
e) receiving a user input from the user interface of the local blade cabinet selecting a server blade to be deleted from the first cluster of server blades; and
f) deleting information identifying the server blade to be deleted from the information stored in step b).

28. The computer readable medium of claim 27, wherein
the method additionally includes, between steps a) and c), transmitting an indication of a hot-plug event to each of the server blades within the local blade cabinet and within the first cluster of server blades,
a USB host controller within each server blade within the local blade cabinet interprets the hot-plug indication as an indication that a first mass storage device has been plugged into a USB network connected to the USB host controller,
in step d), the information is transmitted as information available at the first mass storage device,
the method additionally includes, following step e), transmitting an unplug event to the server blade to be deleted, and
the USB host controller within each server blade within the local blade cabinet interprets the unplug indication as an indication that a first mass storage device has been unplugged from the USB network connected to the USB host controller.

29. The computer readable medium of claim 22, wherein the method additionally comprises steps of:
e) accepting a user input from the user interface selecting a second cluster of server blades within the interconnected blade cabinets;
f) storing information identifying server blades within the second cluster of server blades;
g) reading information from a computer readable medium within a second local drive device of the local blade cabinet; and
h) transmitting the information read in step g) to each server blade within the second cluster of server blades while preventing transmission of the information read in step g) to server blades within the plurality of interconnected blade cabinets and not within the first cluster of server blades.

30. The computer readable medium of claim 22, wherein the method additionally comprises steps of
e) accepting a user input from the user interface selecting a second cluster of server blades within the interconnected blade cabinets;
f) storing information identifying server blades within the second cluster of server blades;
g) accepting a user input from the user interface indicating that information is to be transmitted to server blades within the second cluster of server blades; and
h) in response to step g), transmitting information to each server blade within the second cluster of server blades while preventing transmission of the information read in step g) to server blades within the plurality of interconnected blade cabinets and not within the first cluster of server blades.

31. A computer data signal embodied in a carrier wave comprising code for a program causing a management computer system within a blade cabinet to perform a method for transmitting information to server blades within a plurality of interconnected blade cabinets, wherein the method comprises steps of:
a) accepting a user input from a user interface of a local blade cabinet among the plurality of interconnected blade cabinets, wherein the user input selects a first cluster of server blades within the interconnected blade cabinets;
b) storing information identifying server blades within the first cluster of server blades;
c) reading information from a computer readable medium within a first local drive device of the local blade cabinet; and
d) transmitting the information read in step c) to each server blade within the first cluster of server blades while preventing transmission of the information read in step c) to server blades within the plurality of interconnected blade cabinets and not within the first cluster of server blades.

32. The computer data signal of claim 31, wherein
the first cluster of server blades includes at least one server blade within the local blade cabinet and at least one server blade within a remote blade cabinet within the plurality of interconnected blade cabinets, and
the information is transmitted to at least one server blade within the local server through a local internal network within the local blade cabinet and to at least one server blade within the remote blade cabinet through a management network connecting the interconnected blade cabinets and through a remote internal network within the remote blade cabinet.

33. The computer data signal of claim 31, wherein
the method additionally includes, between steps a) and c), transmitting an indication of a hot-plug event to each of the server blades within the local blade cabinet and within the first cluster of server blades,
a USB host controller within each server blade within the local blade cabinet interprets the hot-plug indication as an indication that a first mass storage device has been plugged into a USB network connected to the USB host controller, and
in step d), the information is transmitted as information available at the first mass storage device.

34. The computer data signal of claim 31, wherein, in step d), the information is transmitted to a virtual USB device emulated within a device part within the local blade cabinet connected to a USB host controller within each server blade within the local blade cabinet and within the first cluster of server blades.

35. The computer data signal of claim 31, wherein the method additionally comprises steps of:
e) receiving information within the local blade cabinet transmitted from a remote blade cabinet through a management network interconnecting the blade cabinets; and
f) transmitting the information received in step e) to each server blade within the first cluster of server blades and within the local blade cabinet, while preventing the transmission of the information received in step e) to each server blade within the local blade cabinet and not within the first cluster of server blades.

36. The computer data signal of claim 31, wherein the method additionally comprises steps of:
e) receiving a user input from the user interface of the local blade cabinet selecting a server blade to be deleted from the first cluster of server blades; and
f) deleting information identifying the server blade to be deleted from the information stored in step b).

37. The computer data signal of claim 36, wherein
the method additionally includes, between steps a) and c), transmitting an indication of a hot-plug event to each of the server blades within the local blade cabinet and within the first cluster of server blades,
a USB host controller within each server blade within the local blade cabinet interprets the hot-plug indication as an indication that a first mass storage device has been plugged into a USB network connected to the USB host controller,
in step d), the information is transmitted as information available at the first mass storage device,
the method additionally includes, following step e), transmitting an unplug event to the server blade to be deleted, and
the USB host controller within each server blade within the local blade cabinet interprets the unplug indication as an indication that a first mass storage device has been unplugged from the USB network connected to the USB host controller.

38. The computer data signal of claim 31, wherein the method additionally comprises steps of:
e) accepting a user input from the user interface selecting a second cluster of server blades within the interconnected blade cabinets;
f) storing information identifying server blades within the second cluster of server blades;
g) reading information from a computer readable medium within a second local drive device of the local blade cabinet; and
h) transmitting the information read in step g) to each server blade within the second cluster of server blades while preventing transmission of the information read in step g) to server blades within the plurality of interconnected blade cabinets and not within the first cluster of server blades.

39. The computer data signal of claim 31, wherein the method additionally comprises steps of
e) accepting a user input from the user interface selecting a second cluster of server blades within the interconnected blade cabinets;
f) storing information identifying server blades within the second cluster of server blades;
g) accepting a user input from the user interface indicating that information is to be transmitted to server blades within the second cluster of server blades; and
h) in response to step g), transmitting information to each server blade within the second cluster of server blades while preventing transmission of the information read in step g) to server blades within the plurality of interconnected blade cabinets and not within the first cluster of server blades.
